(19) United States
(12) Patent Application Publication
(10) Pub. No.: US 2002/0154629 A1
(43) Pub. Date: Oct. 24, 2002

(54) Integrated PMP-radio and DSL multiplexer and method for using the same

(76) Inventors: Michael Lohman, Germantown, MD (US); Tariq Muhammad, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 09/915,811

(22) Filed: Jul. 26, 2001

Related U.S. Application Data
(60) Provisional application No. 60/285,847, filed on Apr. 23, 2001.

(51) Int. Cl. H04L 12/50

(52) U.S. Cl. 370/386; 370/535

(57) ABSTRACT

A method and system are provided for communicating a wireless signal between an integrated wireless Digital Subscriber Line Multiplexer (WDSLAM) and a wireless hub via a wireless link. The wireless signal includes status information concerning queue utilization levels within the WDSLAM. Upon receiving the wireless signal, the wireless hub determines the queue utilization levels of the WDSLAM and selectively allocates bandwidth among WDSLAMs ensuring efficient utilization of bandwidth.

### CROSS REFERENCE TO RELATED APPLICATIONS

This application claims benefit under 35 U.S.C. §119(e) of a provisional U.S. patent application of Michael Lohman et al. entitled “Integrated PMP-Radio and DSL Multipexer”, Ser. No. 60285847, filed on Apr. 23, 2001, the entire content of which is incorporated by reference.

### FIELD OF THE INVENTION

The present invention relates to the field of communications, and in particular, to an improved method and system for providing integrated Point-to-Multipoint (PMP) radio Digital Subscriber Line service (DSL). More specifically, the present invention relates to a system and method for using an improved DSL interface for coupling to a PMP subscriber radio without the use of a separate DSL access multiplexer.

### BACKGROUND OF THE INVENTION

Currently, Digital Subscriber Line service (DSL) service is being heavily advertised by telecommunication service providers. Demand for the service has grown, but telecommunication service providers have found it difficult to keep pace with demand due to the limitations of traditional DSL service. Typically, DSL is provided via “twisted pair”. Specifically, an Integrated Access Device (LAD) is provided to the customer and a copper line AKA “twisted pair” connects the telecommunication service provider's Digital Subscriber Line Access Multiplexer (DSLAM) to the IAD.

The conventional method is to connect the DSLAM to an Asynchronous Transfer Mode (ATM) network via an optical or digital carrier. Acquiring a carrier can be a tedious process since DSLAMs can be located almost anywhere, for example, the basement of a large apartment building. If a carrier is not available to serve the DSLAM, one has to be designed, equipment ordered and the carrier tested. The process can take weeks, and many customers would not want to wait that long for Digital Subscriber Line (DSL) service.

Wireless systems connecting the DSLAM to the ATM network overcome the problems encountered with traditional “wire-line carrier” based DSL systems, in which a “wireless hub” rather than a landline head end communicates with the DSLAMs.

However, a new problem is encountered because the wireless hub of the DSL system is separate from the DSLAM. Specifically, problems of redundancy of design and a lack of proper bandwidth allocations is encountered. More specifically, the wireless hub of the DSL system, typically, has an Asynchronous Transfer Mode (ATM) interface card which interfaces with the ATM based DSLAM. The functionality performed by both the wireless hub and DSLAM are the same. However, the Quality of Service (QOS) levels may be managed differently for the two devices. That is, the DSLAM could have a lower priority for QOS than the wireless hub.

The wireless hub also does not have the capability of determining the instantaneous traffic allocation status of the DSLAM. Thus, the wireless hub could be communicating traffic to the DSLAM via the wireless hub resulting in buffer overflows and/or buffer underflows leading to a bottleneck within the DSL network.

Alternatively, queues and buffers could be overflowing in the DSLAM for traffic towards the wireless hub and the wireless hub would become the bottleneck.

Also, Internet data traffic is an important service for DSL systems. However, Internet traffic is very “bursty” or random in nature. The radio bandwidth of the system is very expensive, and thus an optimal system will only allocate radio bandwidth when it is required. The more responsive the radio network is, the more efficient the use of the radio bandwidth will be. Thus, a greater total throughput will be achieved.

Accordingly, it is an object of the present invention to provide a method and system for providing an integrated wireless digital subscriber line service, in which the DSLAM is integrated into the wireless hub, thus providing an efficient means of dynamically allocating wireless bandwidth to the DSL network with very short response times.

### SUMMARY OF THE INVENTION

In accordance with the present invention, a method and system are provided for transmitting and receiving a wireless signal between an integrated wireless Digital Subscriber Line Multiplexer (WDSLAM) and a wireless hub via a wireless link. The wireless signal includes status information concerning priority levels of queues and/or queue utilization levels within the WDSLAM.

In particular, upon receiving the wireless signal, the wireless hub determines the priority levels of queues and the queue utilization levels of the WDSLAM and selectively allocates bandwidth. More particularly, the wireless hub selectively allocates bandwidth among WDSLAMs ensuring efficient utilization of bandwidth.

### BRIEF DESCRIPTION OF THE DRAWINGS

The details of the present invention can be readily understood by considering the following detailed description in conjunction with accompanying drawing, and with:

FIG. 1 depicts a high level block diagram of a communication system according to an embodiment of the invention;

FIG. 2 depicts a high level block diagram of a DSL interface card for providing Asynchronous Transfer Mode (ATM) cells for use in the communication system of FIG. 1;

FIG. 3 depicts a high level block diagram of a DSL interface card for providing Internet Protocol (IP) packets for use in the communication system of FIG. 1;

FIG. 4 depicts a high level block diagram of a controller useful for implementing the embodiment of the invention shown in FIG. 1;

FIG. 5 depicts a flow diagram illustrating exemplary operations that can be performed by the system and its components shown in FIGS. 1 through 3 in accordance with an embodiment of the present invention; and

FIG. 6 depicts a flow diagram illustrating exemplary operations that can be performed by the system and its components shown in FIGS. 1 through 3 in accordance with an alternate embodiment of the present invention

To facilitate understanding, identical reference numerals have been used, where possible, to designate identical elements that are common to the figures.

### DETAILED DESCRIPTION OF THE INVENTION

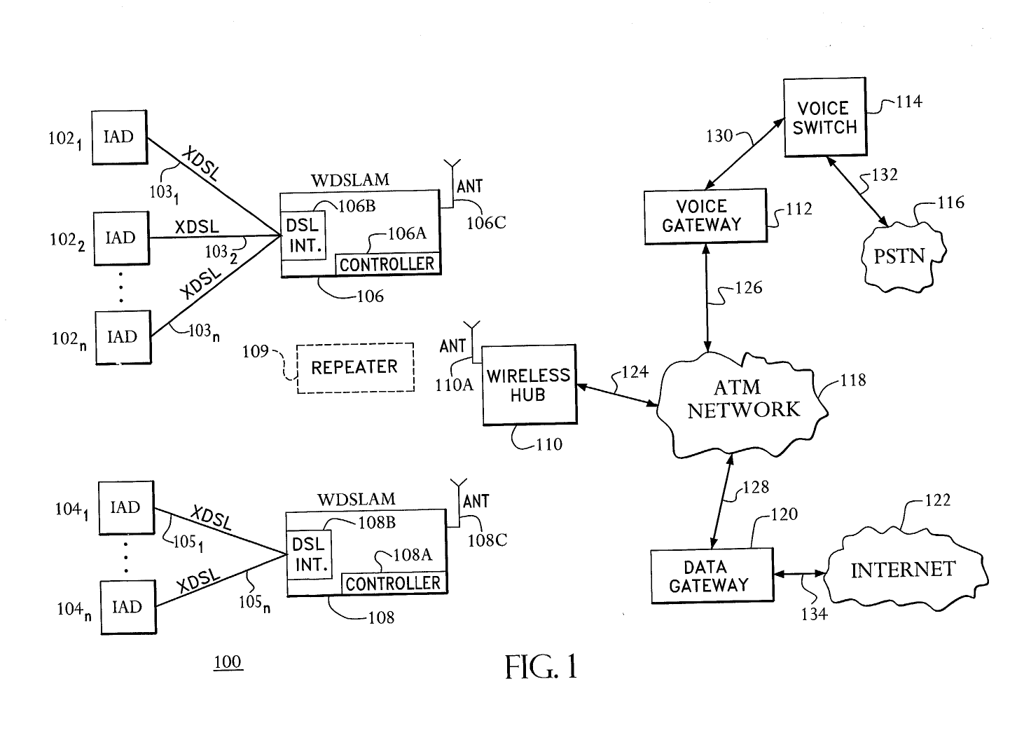

FIG. 1 depicts a high level block diagram of a communications system according to an embodiment of the invention. Specifically, the communications system 100 of FIG. 1 comprises a first plurality of Integrated Access Devices (LADs) denoted as ¹⁰²1, 102₂ up to 102ₙ (hereinafter referred to as first plurality of LADs 102), which are coupled to a first integrated wireless Digital Subscriber Line Access Multiplexer (WDSLAM) 106 including a first controller 106A, a first Digital Subscriber Line (DSL) interface card 106B and a first antennae 106C via a first plurality of links denoted as 1031, 1032 to 103ₙ (hereinafter referred to as link 103), a second plurality of LADs which are denoted as 104₁ to 104ₙ (hereinafter referred to as second plurality of IADs 104) which are coupled to a second integrated WDSLAM 108 including a second controller 108A, a second DSL interface card 108B and a second antennae 108C via a second plurality of links denoted as 105₁ to 105ₙ (hereinafter referred to as 105). The system 100 also includes a wireless hub 110 including a third antennae 110A, an optional repeater 109 for extending the signaling range of wireless hub 110 and WDSLAMs 106 and 108. An Asynchronous Transfer Mode (ATM) network 118 is coupled to wireless hub 110 via third link 124, a voice gateway 112 is coupled to the ATM network 118 via link 126, a voice switch 114 is coupled to the voice gateway 112 via a sixth link 130, a Public Switched Telephone Network (PSTN) 116 is coupled to the voice switch 114 via a seventh link 132, a data gateway 120 is coupled to the ATM network 118 via a fifth link 128, Internet 122 is coupled to the data gateway 120 via eight link 134.

It will be appreciated by those skilled in the art that although the invention is described in the context of LADs other types of modems such as DSL modems, cable modems and the like may be substituted and still fall within the scope of the invention.

The first plurality of IADs 102 accepts various signal formats. For example, LAD 102₁ can accept a Time Division Multiplexed (TDM) T1 carrier signal (not shown). IAD 102₂ can accept a Frame Relay signal (not shown), while IAD 102ₙ can accept an Ethernet Internet Protocol (IP) formatted signal (not shown). LAD 102 can also receive Plain Old Telephone Service (POTS) signal or any subset of a POTS signal. The various signals are formatted into appropriate Asynchronous Transfer Mode Adaptation Layer (AAL) classes. The AAL maps user information into ATM cells and accounts for transmission errors and may also transport timing information so that the destination can regenerate the time dependent signals.

The class of service the user information is mapped to is dependent on the user application and is done in a conventional manner. For example, a voice application may be mapped into a different class of service than a data application due to the critical nature of voice, which requires a low latency and may receive a higher priority level. The classes of service the user information may be mapped to are Asynchronous Transfer Mode Adaptation Layer 1 (AAL1), Asynchronous Transfer Mode Adaptation Layer 2 (AAL2) and Asynchronous Transfer Mode Adaptation Layer 5 (AAL5).

Although the present invention is described in the context of an ATM environment, it will be appreciated by those skilled in the art that the present invention can be practiced with native IP using several conventional class of service techniques such as but not limited to Multi protocol Label Switching (MPLS) and/or Differentiated Services (Diff Serve). For example, the ATM network described above may be substituted with an IP network.

The AAL formatted signal is then converted into a DSL signal for communication over a transmission medium such as first plurality and second plurality of links 103 and 105. It will be appreciated by those skilled in the art that the present invention is not limited to a particular DSL technology type. The invention can be practiced using Asymmetrical Digital Subscriber Line (ADSL), High Speed Digital Subscriber Line (HDSL), ISDN Digital Subscriber Line (ISDL), Symmetrical Digital Subscriber Line (SDSL), Universal ADSL (UADSL) also known as “G.Lite” and Very High Bit-rate Digital Subscriber Line (VDSL), Ethernet DSL and the like. In addition, the present invention can be practiced using a Discrete Multi-Tone (DMT) and/or Carrierless Amplitude and Phase (CAP) formatted DSL signal. Additionally, T1 and E1 carriers and/or a cable modem system can be used.

The DSL formatted signal is communicated to the first WDSLAM 106 via first plurality of links 103. First plurality of links 103 is typically “twisted pair” copper wire but other physical transmission mediums, such as coaxial cable, may be substituted and still fall within the scope of the present invention.

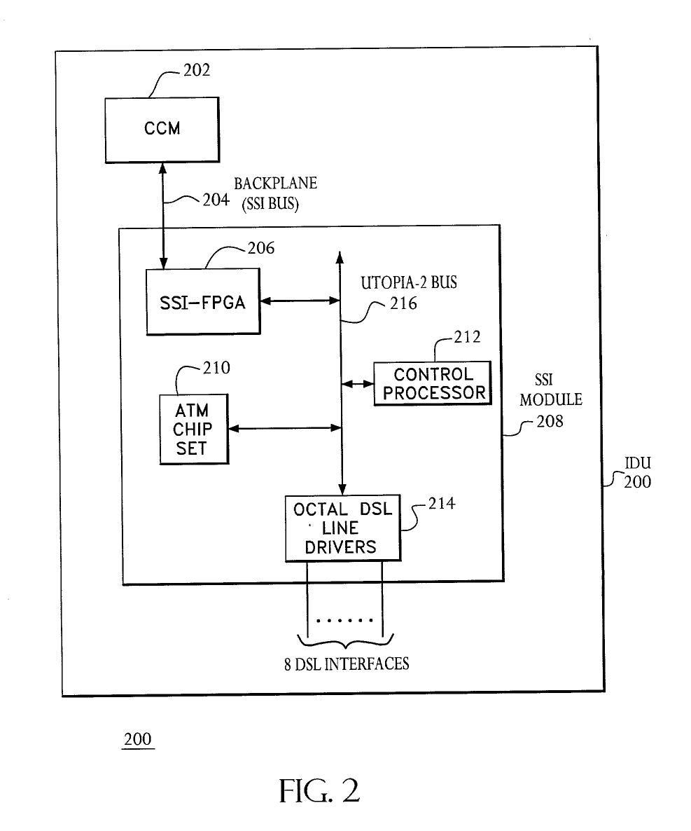

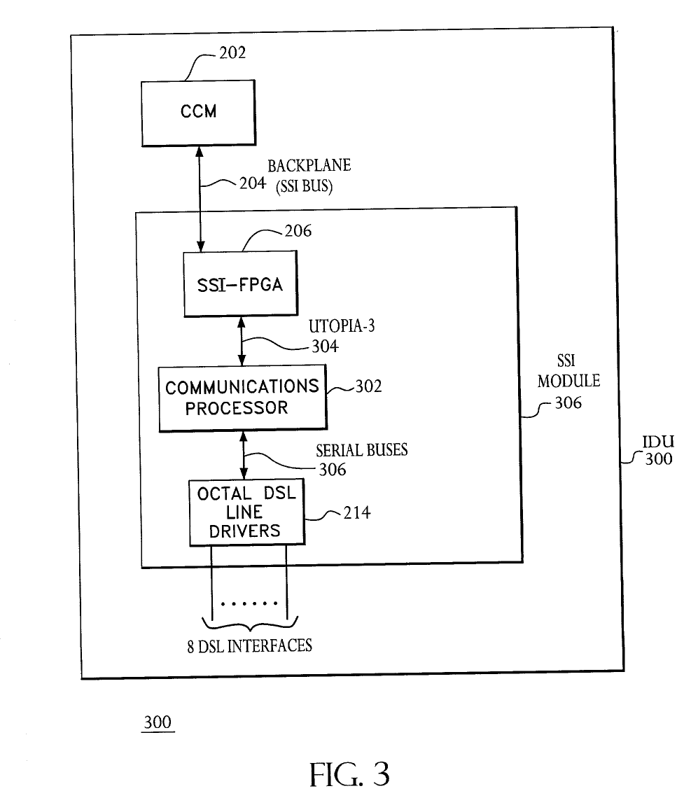

First WDSLAM 106 is an integrated DSLAM and wireless radio system. The wireless radio system may be a Point-to-Multipoint (PMP) radio system but may also be a Point-to-Point (PP) radio system. Included in first WDSLAM 106 is first DSL interface card 106B which will be discussed in greater detail with reference to FIG. 2 and controller 106A which will be discussed in greater detail with reference to FIG. 3. First DSL interface card 106B converts the DSL formatted signal back into an ATM formatted signal while controller 106A controls the operation of WDSLAM 106. The ATM signal is then formatted into a wireless signal for transmission via antennae 106C to the wireless hub 110 which receives the wireless signal via antennae 110A. A typically range for WDSLAM 106 and wireless hub 110 is about 4 kilometers. However, the use of one or more repeaters such as repeater 109 can greatly increase this range. Repeater 109 serves to regenerate the wireless signal communicated between wireless hub 110 and WDSLAM 106.

Wireless hub 110 acts as a processing center and receives messages from various WDSLAMs concerning queue priority levels and queue utilization levels for each WDSLAM. Specifically, each WDSLAM assigns a set of queues to each DSL line. There is, typically, one queue for each QOS level per line. As user information comes into the WDSLAM via an IAD, the user information is stored in a respective queue based on the header information in the traffic. Priority levels are preassigned to the user and/or the user information. For example, based on a Service Level Agreement (SLA) a user may have with a service provider, the user may be guaranteed a specific priority and bandwidth.

As a further example, the invention can be described using two users and different scenarios but it will be appreciated by those skilled in the art that the present invention is not limited to the two users and the scenarios described herein.

In a first scenario, user A may have a priority level of 1 but may only require a low bandwidth. User B may have a lower priority level of 2 but require a high bandwidth level according to the SLA. User B will have a higher priority than users having a lower priority level of 3, 4 and 5 allowing User B's information to be transmitted first over users having a lower priority level. However, user B must wait for user A to transmit information first from the queue before user B can transmit information. Although user A has a low bandwidth demand, user A still transmits information from the queue first because user A has a higher priority level. Once user A's information has been transmitted from the queue, then user B's information can be transmitted.

In a second scenario, users A and B can have the same priority level. In this case, wireless hub 10 will allow each WDSLAM to communicate traffic to wireless hub 110 in a round robin fashion assuming the depth level of the queue or queue utilization levels are the same. That is, wireless hub 10 selectively assigns bandwidth to WDSLAMs based on the priority level of queues and the status of the queue utilization levels which the WDSLAMs communicate to the wireless hub.

In a third scenario, users A and B have the same priority level, but user A has twice the guaranteed bandwidth as user B according to the SLA. In this case, a weighted round robin algorithm is used to allocate the bandwidth to users A and B. In other words users A and B have the same priority level, but more bandwidth is allocated for user A based on user A's greater demand for bandwidth.

The preferred wireless format is Time Division Multiple Access (TDMA), but it will be appreciated by those skilled in the art that other wireless formats such as Code Division Multiple Access (CDMA), cellular and the like may be substituted and still fall within the scope of the present invention.

Second WDSLAM 108, DSL interface card 108B, controller 108A, antennae 108C, second plurality of IADs, second plurality of links 105 operate similarly to first WDSLAM 106, controller 106A, DSL interface card 106B, antennae 106C and transmission medium 103.

Referring back to wireless hub 110, wireless hub 110 selectively allocates bandwidth to a WDSLAM allowing the WDSLAM to communicate the contents of its queue. The received wireless signal is converted back to an ATM formatted signal at wireless hub 110. Wireless hub 110, in turn, communicates the ATM formatted signal to the ATM network 118 via link 124. Third link 124, fourth link 126, fifth link 128, sixth link 130, seventh link 132 and eight link 134 are preferably an optical carrier level 3 (OC-3) which carries optical information at 155.52 Mb/s or digital signal level 3 (DS3) which carries digital information at 45 Mb/s but may be a digital signal level 1 (DS1) which carries digital information at 1.544 Mb/s, digital signal level 2 (DS2) which carries digital information at 6.312 Mb/s, European signal level 1 (E1) which carries digital information at 2.048 Mb/s, European signal level 2 (E-2) which carries digital information at 8.448 Mb/s, European signal level 3 (E-3) which carries digital information at 34.37 Mb/s, optical carrier level 1 (OC-1) which carries optical information at 51.84 Mb/s, optical carrier level 12 (OC-12) which carries optical information at 622.08 Mb/s, optical carrier level 48 (OC-48) which carries optical information at 2.48 Gb/s, optical carrier level 96 (OC-96) which carries optical information at 4.97 Gb/s and/or an optical carrier level 192 (OC-192) which carries optical information at 13,271.04 Gb/s.

In addition the present invention can also be practiced with a synchronous transport signal (STS-n) which is the electrical equivalent of an OC-n signal, a Gigabit Ethernet signal (1.2 Gb/s) or an IP packet over SONET signal (1.55 Mb/s).

The ATM network 118 separates voice and data signals in a conventional manner based on the cell header and directs the user signal to the appropriate voice or data network. Illustratively, the voice portion of the user signal is depicted as going to the voice gateway 112 via carrier 126 which is preferably an OC-3 or DS3 carrier. Voice gateway 112 then communicates the user signal to voice switch 114 via carrier 130 which can be a DS1. The user information is routed to the PSTN 116 via carrier 132 which can also be a DS1. That is, the user information is routed through the PSTN 116 as a conventional call.

ATM network 118 also handles the data portion of the user information. The data portion is communicated to the data gateway 120 via carrier 128 which can be an OC-3 or DS3 carrier. Data gateway 120 may process the signal and modify the data type. For instance, the data type may change from an ATM format to a Real Time Transport Protocol (RTP) and/or (User Datagram Protocol (UDP) format. The user information is then communicated to the Internet 122 via carrier 134 which can be an OC-3 or DS3.

It will be appreciated by those skilled in the art that although the invention is described as occurring in one direction from the user to the ATM network, the novelty of the invention also occurs in the opposite direction which is from the ATM network to the user.

FIG. 2 depicts a high level block diagram of a DSL interface card for use in the communication system of FIG. 1. Specifically, FIG. 2 depicts a indoor unit (IDU) 200. More specifically, IDU 200 depicts DSL interface card 106B which comprises a channel and conference module (CCM) 202, a backplane bus 204, a DSL SSI module 208 which includes a service specific interface field programmable gate array module (SSI-FPGA) 206, an ATM chipset 210, a control processor 212, octal DSL line drivers 214 and a utopia-2 bus 216. Also, the present invention can be implemented to allow the CCM 202 to be located on the interface card 106B or to be located separately from the interface card 106B.

Utopia-2 bus 216, which is an ATM forum standard, is coupled to control processor 212, SSI-FPGA 206, ATM chipset 210, and octal line drivers 214. The backplane bus 204 which is depicted as a SSI bus is coupled to CCM 202, and SSI module 208 via the SSI-FPGA 206.

As a DSL formatted signal arrives from the LAD, the octal line DSL drivers 214 receives the signal and converts the DSL signal to an ATM signal. Illustratively, DSL interface card 106B is depicted as accepting up to eight DSL interfaces or users. However, those skilled in the art will appreciate that the present invention can be practiced with at least one user or interface and still fall within the scope of the present invention.

Octal DSL line drivers 214 communicates the ATM signal to the ATM chipset 210 via the utopia-2 bus 216. The ATM signal conveys information from a user and has a priority level associated with the information. The ATM chipset 212 stores the ATM information in queues based on a priority level and performs policing and queuing in accordance with ATM Standards Traffic Management TM 4.0 which is herein incorporated by reference in its entirety. Status information concerning the queues is communicated between the control processor and the CCM 202 via the utopia-2 bus 216 and backplane bus 204. The status information concerns the priority levels of queues and the number of cells in the queues which is also known as the queue utilization level. Additional functions performed by the control processor are ATM address translations, monitoring the card for alarms, queue depth and performance monitoring information.

SSI-FPGA 206 retrieves ATM cells from the ATM chipset 210, handles timing based on TDMA and converts the ATM cells to a digital multiplexed signal format allowing the transport of the signals over the backplane bus 204 to the CCM 202.

Upon receiving the digital signal from the SSI-FPGA 206, CCM 202 acts as a modulator/demodulator and performs forward error correction on the signal along with synchronization and timing functions. The signal is converted to a wireless signal utilizing, for example, the TDMA format and communicated to an antennae where the signal is received by the wireless hub.

FIG. 3 depicts a high level block diagram of a DSL interface card for providing Internet Protocol (IP) packets for use in the communication system of FIG. 1. More specifically, FIG. 3 depicts an (IDU) 300 for providing IP frames over Ethernet-DSL. More specifically, IDU 300 depicts DSL interface card 106B which comprises the CCM 202, the backplane 204 which is illustratively depicted as a SSI bus, a SSI module 306 which includes the SSI-FPGA 206, the octal DSL line drivers 214, a communications processor 302, a Utopia-3 bus 304, and a plurality of serial buses 306 illustratively depicted as eight serial buses.

Backplane 204 couples CCM 202 to SSI-FPGA 206. SSI-FPGA 206 is, in turn, coupled to communications processor 302 via Utopia-3 bus 304. A plurality of serial buses 306 couple octal line drivers 214 with communications processor 302. Line interfaces extending from octal line drivers 214 allow user interaction.

Since IDU 300 operates in a similar manner to IDU 200, only differences between the two devices will be discussed. IP packets are transmitted within an Ethernet-DSL signal to the octal line drivers 214 via one or more of the DSL interfaces. As previously discussed above with reference to FIG. 2, each one of the DSL interfaces represents a DSL interface to a customer. When the signal arrives at the octal line drivers 214, the DSL portion of the signal is removed and the IP packet information is communicated to the communications processor 302 via a respective one or more of the plurality of serial buses 306.

Communications processor 302 performs the queuing, policing and routing functions in a similar manner as the ATM chipset 210 as well as the control process function. However, the Utopia-3 bus allows the communications processor 302 to send entire packets to the SSI-FPGA 206.

The SSI-FPGA 206, in turn, retrieves the IP packets from the communications processor 302 and converts the IP packets to a digital signal format, i.e. TDMA, to allow the transport of the signal over the backplane 304 to the CCM 202 where the signal is processed as in FIG. 2.

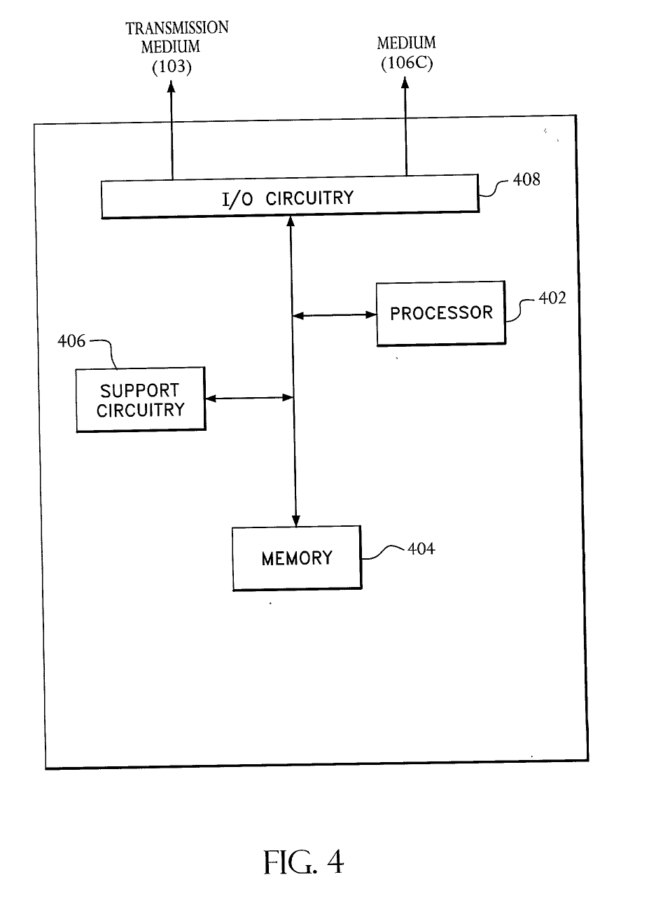

FIG. 4 depicts a high level block diagram of a controller suitable for use in a communication system 100 of FIG. 1. Specifically, the exemplary controller 106A of FIG. 4 comprises a processor 402 as well as memory 404 for storing various control programs such as methods 500 and 600. The processor 402 cooperates with conventional support circuitry 406 such as power supplies, clock circuits, case memory and the like as well as circuits that assist in executing the software routines stored in the memory 404. The controller 106A also contains input/output circuitry 408 which serves as an interface between the various functional elements communicating with the controller 106A. For example, in an embodiment of FIG. 1, the WDSLAM 106 communicates with wireless hub 110 via a wireless link and with first plurality of IADs 102 via a transmission medium 103.

Although the controller 106A is depicted as a general purpose computer that is programmed to perform various controller functions in accordance with the present invention, the invention can be implemented in hardware as, for example, an application specific integrated circuit (ASIC). In addition, the apparatus of the invention may be implemented in a computer program product tangibly embodied in a machine-readable storage device for execution by controller 106A. As such, the process steps described herein are intended to be broadly interpreted as being equivalently performed by software, hardware or a combination thereof.

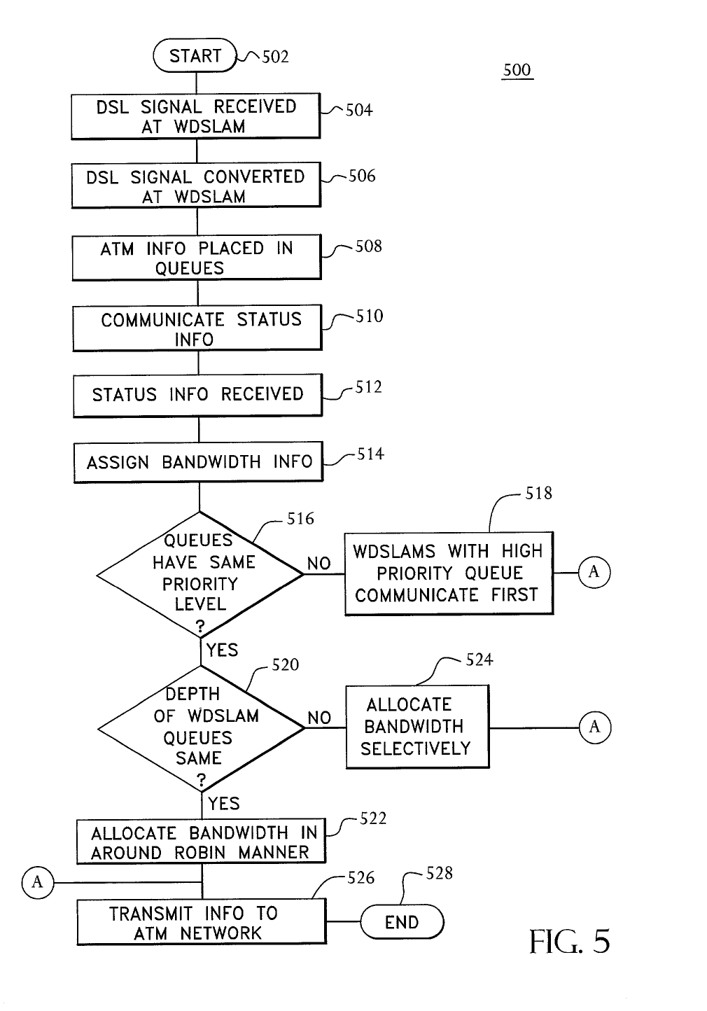

FIG. 5 depicts a flow diagram illustrating exemplary operations that can be performed by the system and its components shown in FIGS. 1 through 3 in accordance with an embodiment of the present invention. Specifically, FIG. 5 depicts a flow diagram of a method 500 for selectively allocating the bandwidth for integrated WDSLAMs.

The method 500 of FIG. 5 is entered at step 502 and proceeds to step 504 where a DSL formatted signal is received at the first integrated WDSLAM 106. The method 500 then proceeds to step 506.

At step 506, the DSL formatted signal is converted back to an ATM signal. That is, the DSL formatted signal was used as a transport format and the information in the DSL formatted signal is retrieved at the WDSLAM.

At step 508, the ATM information is placed in pre-queues based on quality of service (QOS) class. The information is assigned a priority level based on the cell headers and placed in a respective queue determined by the priority level. The method 500 then proceeds to step 510.

At step 510 the first integrated WDSLAM communicates status information concerning the queues to wireless hub 110. That is, CCM 202 communicates the priority levels and queue depth from ATM chipset 212 to wireless hub 110. Wireless hub 110 is given access to the status of all the queues on a user level basis. The method 500 then proceeds to step 512.

At step 512, the status information concerning the first integrated WDSLAM's 106 queues are received. The wireless hub 110 receives status information from at least one WDSLAM. The limit concerning how many WDSLAMs a wireless hub can serve is based on memory, available bandwidth for communicating between the wireless hub and WDSLAMs and processing speed of the wireless hub. The method 500 then proceeds to step 514.

At step 514, the wireless hub 110 assigns bandwidth to the WDSLAMs based on priority level. That is, WDSLAMs with queues having the highest priority get to communicate first. Specifically, wireless hub 110 selectively allocates bandwidth allowing the selected WDSLAM to communicate the contents of the high priority queue to the wireless hub 110. The method 500 then proceeds to step 516.

At step 516 a query is made as to whether queues in the WDSLAMs have the same priority level. If the query at step 516 is answered negatively, the method 500 proceeds to step 518 where the WDSLAMs with the highest priority queue levels communicate the contents of their high priority queue.

If the query at step 516 is answered affirmatively, the method proceeds to step 520 where a query is made as to whether the depth of the queues of each WDSLAM is the same. If the query at step 520 is answered affirmatively, the method 500 proceeds to step 522 where wireless hub 110 allocates bandwidth to WDSLAMs in a weighted round robin manner. The method 500 then proceeds to step 526.

If the query at step 520 is answered negatively, the method 500 proceeds to step 524 where bandwidth is selectively allocated to queues of WDSLAMs having the highest depth. That is, queues having the most ATM cells are allowed to transmit their ATM cells to wireless hub 110 first.

After allowing WDSLAMs with high priority queues to communicate first (step 518) or allocating bandwidth selectively based on queue depths being different for the various WDSLAMs (step 524) the method 500 proceeds to step 526 where the ATM cells are communicated from the wireless hub 110 via a carrier to the ATM network 118 where data, voice and video information is routed to the appropriate network. The method 500 then proceeds to step 528 where it ends.

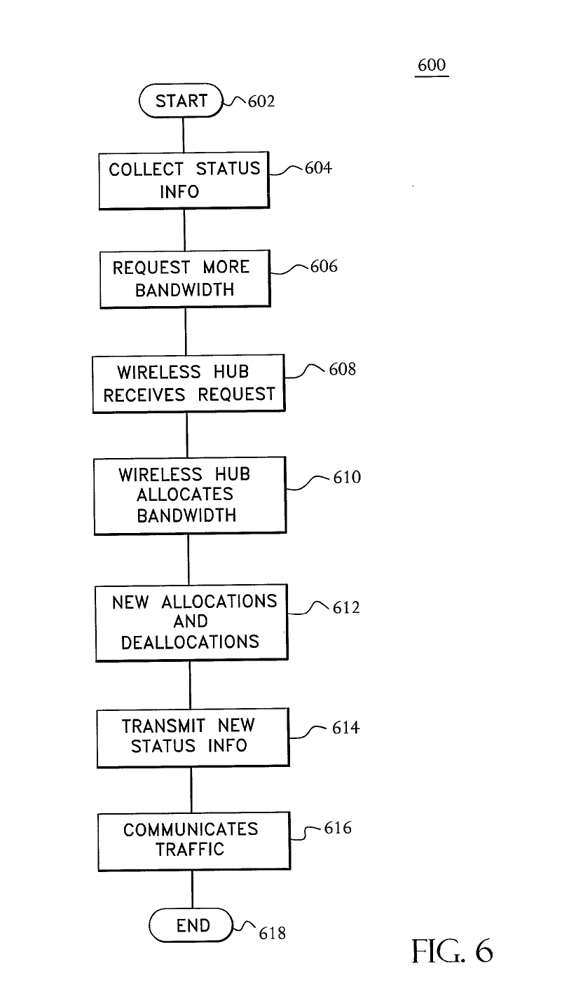

FIG. 6 depicts a flow diagram illustrating exemplary operations that can be performed by the system and its components shown in FIGS. 1 through 3 in accordance with an alternate embodiment of the present invention. Specifically, FIG. 6 depicts a flow diagram of a method 400 for allocating in a weighted round robin manner bandwidth for integrated WDSLAMS.

The method 600 of FIG. 6 is entered at step 602 and proceeds to step 604 where status information is collected at each WDSLAM on the queues associated with the respective incoming traffic. The method 600 then proceeds to step 606.

At step 606, when the queue depths are high, the WDSLAM requests more wireless bandwidth and communicates the highest priority level that is pending transmission to the wireless hub 110. The method 600 then proceeds to step 608 where the wireless hub 1110 receives requests for wireless bandwidth from all WDSLAMs.

At step 610, the method 600, the wireless hub 110 allocates wireless bandwidth based on the priority levels and SLAs of the WDSLAMs in a weighted round robin manner. In other words, WDSLAMs having the same priority levels for packets in queues waiting to be transmitted and SLA's will be assigned wireless bandwith with each WDSLAM receiving its fair share of bandwidth. The method 600 then proceeds to step 612.

At step 612, the WDSLAM receives new allocations and deallocations. That is, incoming traffic is arriving and being assigned to queues for transmission to wireless hub 1 10 creating new status information. Also, traffic in the queues is being communicated to the wireless hub 110. The method 600 then proceeds to step 614 where the WDSLAM transmits the new status information to the wireless hub 110.

At step 616, the wireless hub communicates the traffic it receives from the WDSLAMs to the ATM network 118. The method 600 then proceeds to step 618 where it ends.

It will be appreciated by those skilled in the art that the two methods described above for allocating wireless resources can be utilized in a coaxial cable modem environment via the Data Over Cable Service Interface Specification (DOCIS), herein incorporated by reference, and still fall within the scope of the invention.

Although various embodiments which incorporate the teachings of the present invention have been shown and described in detail herein, those skilled in the art can readily devise many other varied embodiments that still incorporate these teachings.

What is claimed is:

1. A communications system comprising:
a wireless hub for interfacing with a network; and
an integrated Wireless Digital Subscriber Line Access Multiplexer (WDSLAM) adapted to communicate wireless data between said wireless hub and said WDSLAM via a wireless link, wherein said wireless hub has a direct access to queue utilization levels within said WDSLAM.

2. The communication system of claim 1, wherein said wireless data further comprises a Code Division Multiple Access (CDMA) signal.

3. The communication system of claim 1, wherein said wireless data further comprises a Time Division Multiple Access (TDMA) signal.

4. The communication system of claim 1, wherein said wireless data further comprises a cellular signal.

5. The communication system of claim 1, wherein said queue utilization levels further comprises Asynchronous Transfer Mode (ATM) queue utilization levels.

6. The communication system of claim 1, wherein said queue utilization levels further comprises internet Protocol (IP) queue utilization levels.

7. The communication system of claim 1, wherein said wireless hub and WDSLAM have a single feature set.

8. The communication system of claim 7, wherein said single feature set comprises an ATM feature set.

9. The communication system of claim 7, wherein said single feature set comprises an Internet Protocol (IP) feature set.

10. The communication system of claim 1, wherein said wireless hub has access to the queue utilization levels on a per line Digital Subscriber Line (DSL) basis.

11. The communication system of claim 1, wherein each queue is assigned a Quality of Service (QOS) class having a priority level.

12. The communication system of claim 1, wherein said wireless hub allocates bandwidth between said wireless hub and at least one WDSLAM based on at least one of:
a quality of service (QOS) class for pre-assigning a priority and quality level to data;
a Service Level Agreement (SLA) for determining bandwidth guarantees between a user and a service provider; and
the queue utilization levels for determining queues that are at capacity.

13. The communication system of claim 1, wherein said network includes an Asynchronous Transfer Mode (ATM) network.

14. The communication system of claim 1, wherein said network includes an Internet Protocol (IP) network.

15. The communication system of claim 1, wherein said interface is made via a digital carrier.

16. The communication system of claim 15, wherein said digital carrier comprises at least one of:
a Digital Signal Level 1 (DS1);
a Digital Signal Level 2 (DS2); and
a Digital Signal Level 3 (DS3).

17. The communication system of claim 1, wherein said interface is made via an optical carrier.

18. The communication system of claim 17, wherein said optical carrier comprises at least one of:
an Optical Carrier Level 1 (OC-1);
an Optical Carrier Level 3 (OC-3);
an Optical Carrier Level 12 (OC-12);
an Optical Carrier Level 48 (OC-48);
an Optical Carrier Level 96 (OC-96); and
an Optical Carrier Level 192 (OC-192).

19. A method for communicating in a communication system comprising:
transmitting from an integrated wireless Digital Subscriber Line Multiplexer (WDSLAM), a wireless signal, said wireless signal including status information of queue utilization levels within said WDSLAM;
receiving said wireless signal, at a wireless hub;
selectively allocating bandwidth to said integrated WDSLAM in response to the queue utilization level of said WDSLAM.

20. The method of claim 19, wherein said step of selectively allocating bandwidth comprises determining queue utilization levels on a per line Digital Subscriber Line (DSL) basis.

21. The method of claim 19, wherein said status information comprises bandwidth guarantees for data associated with a user.

22. The method of claim 19, further comprising:
allocating bandwidth in a weighted round robin manner among WDSLAMs in response to determining data in queues awaiting transport to said wireless hub for said WDSLAMs have the same priority level.

23. The method of claim 19, further comprising:
allocating bandwidth in a manner determinative of the WDSLAM having the highest queue priority level.

24. The method of claim 19, wherein the greatest amount of bandwidth is assigned to the WDSLAM having queues with the highest priority and utilization level.

25. The method of claim 19, wherein said wireless signal further comprises a Code Division Multiple Access (CDMA) signal.

26. The method of claim 19, wherein said wireless signal further comprises a Time Division Multiple Access (TDMA) signal.

27. The method of claim 19, wherein said wireless signal further comprises a cellular signal.

28. The method of claim 19, wherein said queue utilization levels further comprises Asynchronous Transfer Mode (ATM) queue utilization levels.

29. The method of claim 19, wherein said queue utilization levels further comprises internet Protocol (IP) queue utilization levels.

30. The method of claim 19, wherein said wireless hub and WDSLAM have a single feature set.

31. The method of claim 30, wherein said single feature set comprises an ATM feature set.

32. The method of claim 30, wherein said single feature set comprises an Internet Protocol (IP) feature set.

33. The method of claim 19, wherein said wireless hub has access to the queue utilization levels on a per line Digital Subscriber Line (DSL) basis.

34. An apparatus for communicating in a communications system, said apparatus comprising:
an integrated wireless Digital Subscriber Line Multiplexer (WDSLAM) having an interface card for interfacing with a digital landline network and a wireless network, said interface card including:
a channel and conference module (CCM) adapted to converting a digital signal to a wireless signal;
a service specific interface field programmable gate array (SSI-FPGA) module coupled to the CCM for providing a timed digital signal to said CCM; and
a processor coupled to the SSI-FPGA for monitoring queue utilization levels and informing a wireless hub of said status information.

35. The apparatus of claim 34 further comprising:
Digital Subscriber Line (DSL) drivers coupled to said processor for serving as an interface between said interface card and at least one subscriber.

36. The apparatus of claim 35, wherein said digital signal includes an Asynchronous Transport Medium (ATM) signal.

37. The apparatus of claim 36, further comprising:
an ATM chip set for storing ATM information in accordance with ATM Standards Traffic Management 4.0.

38. The apparatus of claim 37, wherein said processor includes a control processor for providing ATM status information to a wireless hub.

39. The apparatus of claim 35, wherein a backplane couples the CCM and the SSI-FPGA.

40. The apparatus of claim 39, wherein the backplane includes a Service Specific Interface (SSI) bus.

41. The apparatus of claim 38, wherein a Utopia-2 bus couples said ATM chipset, SSI-FPGA, control processor and octal line drivers.

42. The apparatus of claim 34, wherein said wireless signal further comprises a Code Division Multiple Access (CDMA) signal.

43. The apparatus of claim 34, wherein said wireless signal further comprises a Time Division Multiple Access (TDMA) signal.

44. The apparatus of claim 34, wherein said wireless signal further comprises a cellular signal.

45. The apparatus of claim 35, wherein said digital signal includes an Internet Protocol (IP) signal.

46. The apparatus of claim 45, wherein said processor includes a communications processor for grouping IP packets based on Quality of Service (QOS) class.

47. The apparatus of claim 46, wherein said communications processor communicates status information on said IP packets to a wireless hub.

48. The apparatus of claim 47, wherein a Utopia-3 bus couples said SSI-FPGA to said communications processor.

49. The apparatus of claim 48, wherein a plurality of serial buses couples said communications processor to said octal DSL line drivers.

50. An apparatus for communicating wireless information, comprising:
a processor and an associated storage device including instructions for controlling said processor, said instruction, when executed, causing said processor to perform the steps of:
transmitting from an integrated wireless Digital Subscriber Line Multiplexer (WDSLAM), a wireless signal, said wireless signal including status information of queue utilization levels within said WDSLAM;
receiving said wireless signal, at a wireless hub;
selectively allocating bandwidth to said integrated WDSLAM in response to the queue utilization level of said WDSLAM.

51. A method for communicating in a communication system comprising:
receiving data from a modem at an integrated wireless Digital Subscriber Line Multiplexer (WDSLAM);
assigning said data to pre-assigned queues having associated with said queues priority levels;
determining utilization levels of said queues;
transmitting from the integrated WDSLAM, a wireless signal, said wireless signal including status information of the queue utilization levels within said WDSLAM;
receiving said wireless signal, at a wireless hub;
selectively allocating bandwidth to said integrated WDSLAM in response to the queue utilization level of said WDSLAM; and
communicating wireless data to said WDSLAM based on the priority level of the queues.
